(19) United States
(12) Patent Application Publication
(10) Pub. No.: US 2016/0224958 A1
(43) Pub. Date: Aug. 4, 2016

(54) Sliding Scale Payments System and Method

(71) Applicant: MasterCard International Incorporated, Purchase, NY (US)

(72) Inventors: Kenny Unser, Fairfield, CT (US); Harrison Siegel, White Plains, NY (US)

(21) Appl. No.: 14/609,246

(22) Filed: Jan. 29, 2015

(51) Int. Cl. G06Q 20/14; G06Q 20/40

(52) U.S. Cl. CPC G06Q 20/145; G06Q 20/4016

(57) ABSTRACT

A system, method, and computer-readable storage medium configured to reduce the computational burden of commercial enterprises supplying sliding scale fees.

### BACKGROUND

1. Field of the Disclosure

Aspects of the disclosure relate in general to commercial services. Aspects include a method and analysis platform to reduce the computational burden of commercial enterprises to support sliding scale fees.

2. Description of the Related Art

A payment card is a card that can be used by an accountholder and accepted by a merchant to make a payment for a purchase or in payment of some other obligation. Payment cards include credit cards, debit cards, charge cards, and Automated Teller Machine (ATM) cards. Payment cards provide the clients of a financial institution (“accountholders”) with the ability to pay for goods and services without the inconvenience of using cash.

In a different art, many commercial enterprises offer need-based fee scales. These include healthcare businesses, lawyers, educational institutions, labor unions, and religious organizations. Generally, there is a burden of proof or other such application process involved in determining the fee for a given good or service. There is also administrative cost to supporting sliding scale payments.

### SUMMARY

Embodiments include a system, device, method and computer-readable medium to reduce the computational burden of commercial enterprises supplying sliding scale fees.

The system includes a processor and a network interface. The network interface is configured to receive transaction data from a merchant bank. The transaction data describes the payment transaction and includes: an account identifier associated with the accountholder, a merchant identifier, an amount of the transaction and a sliding scale identifier. The processor matches the merchant identifier and the sliding scale identifier with a billing scale entry in a database. The billing scale entry includes billing scale requirements and a billing scale. The processor matches the account identifier with an accountholder entry in a database. The accountholder entry includes accountholder data. The processor determines whether the accountholder qualifies for sliding scale pricing based at least in part on the billing scale requirements and the accountholder data. When the accountholder qualifies for sliding scale pricing, the processor calculates a suggested bill amount based on the billing scale entry. The network interface transmits to the merchant bank the suggested bill amount when the accountholder qualifies for sliding scale pricing.

### BRIEF DESCRIPTION OF THE DRAWINGS

FIG. 1 is a block diagram illustrating a payment network to reduce the computational burden of commercial enterprises supplying sliding scale fees.

FIG. 2 is an expanded block diagram of an exemplary embodiment of a server architecture of a payment network embodiment configured to reduce the computational burden of commercial enterprises supplying sliding scale fees.

FIGS. 3A-B illustrate a real time authorization process, from the perspective of a payment network, to reduce the computational burden of commercial enterprises supplying sliding scale fees.

### DETAILED DESCRIPTION

One aspect of the disclosure includes the realization that the information gathering and collection for need-based sliding scale payments is burdensome and inefficient. Additionally, as many merchants or vendors provide such sliding scale payments, the process is repeated by each organization offering such a payment program. The repeated collection of the same or similar information by each party is onerous on the customer/purchaser.

Another aspect of the disclosure is the understanding that a central location can be used to collect accountholder data, and assess the accountholder's participation in a sliding scale payment program.

Aspects of the disclosure include a method and system of making fee assessments and allowing merchants to determine payments owed by each accountholder in a more efficient manner.

Another aspect of the disclosure is the realization that once the accountholder data is collected, accountholders may want to restrict access to selected merchants.

While embodiments described herein are applied to a payment network and point-of-sale context, it is understood by those familiar with the art that the concepts, apparatus, system and methods described herein may also be applicable to an issuer and point-of-sale context.

The systems and processes are not limited to the specific embodiments described herein. In addition, components of each system and each process can be practiced independently and separately from other components and processes described herein. Each component and process also can be used in combination with other assembly packages and processes.

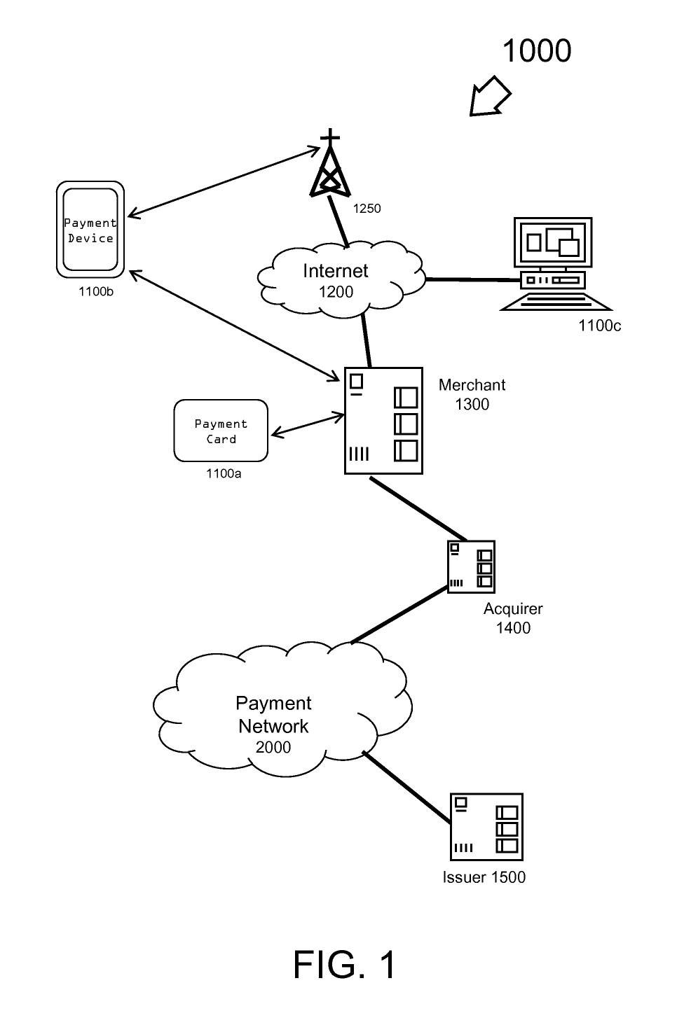

FIG. 1 is a block diagram 1000 illustrating a system and method of making fee assessments and allowing merchants to determine payments owed by each accountholder in a more efficient manner. The present disclosure is related to a payment system, such as a credit card payment system using a payment network 2000, such as the MasterCard® interchange, Cirrus® network, or Maestro®. The MasterCard interchange is a proprietary communications standard promulgated by MasterCard International Incorporated of Purchase, N.Y., for the exchange of financial transaction data between financial institutions that are customers of MasterCard International Incorporated. Cirrus is a worldwide interbank network operated by MasterCard International Incorporated linking debit and payment devices to a network of ATMs throughout the world. Maestro is a multi-national debit card service owned by MasterCard International Incorporated.

In a financial payment system, a financial institution called the “issuer” 1500 issues a payment account to a consumer, who uses payment device 1100a-c to tender payment for a sliding scale purchase from merchant 1300. Payment devices may include a payment card 1100a, mobile device 1100b (such as key fobs, mobile phones, tablet computers, Personal Digital Assistants (PDAs), electronic wallets and the like), or computers 1100c. Payment devices may be used to tender purchase in-person at merchant 1300, or when connected via a mobile telephone network 1250 or the internet 1200.

In this example, a user makes a purchase at merchant 1300; the sale may include goods or services that are subject to a sliding scale pricing system. User presents the payment device 1100 to a point-of-sale device at merchant 1300. The merchant 1300 is affiliated with a financial institution. This financial institution is usually called the “merchant bank,” “acquiring bank” “acquirer bank,” or “acquirer” 1400. When a payment device 1100 is tendered at merchant 1300, the merchant 1300 electronically requests authorization from the acquirer 1400 for the amount of the purchase. The authorization request includes an indicator or indicators that certain goods or services are subject to the sliding scale pricing system. The indicators may directly relate to the goods and services. The request is performed electronically with the consumer's account information. For payment cards, the consumer's account information may be retrieved from the magnetic stripe on a payment card 100a or via a computer chip imbedded within the card 1100a. For other types of payment devices 1100b-c, the consumer's account information may be retrieved by wireless methods, such as contactless communication like MasterPass® or via Near Field Communication (NFC). The account information, along with the sliding scale pricing indicator, is forwarded to transaction processing computers of the merchant bank 1400. Alternatively, a merchant bank 1400 may authorize a third party to perform transaction processing on its behalf. In this case, the merchant 1300 will be configured to communicate with the third party. Such a third party is usually called a “merchant processor” or an “acquiring processor” (not shown).

The computers of the acquirer 1400 or the merchant processor will communicate, via payment network 2000, with the computers of the issuer bank 1500 to determine whether the consumer's account is in good standing and whether the accountholder qualifies for sliding scale purchase. It is understood that any number of issuers 1500 may be connected to payment network 2000.

Based on the sliding scale pricing indicator and the consumer's account information, the payment network 2000 or issuer 1500 retrieves accountholder data to determine whether the consumer qualifies for the sliding scale pricing. When the consumer qualifies for the sliding scale pricing, the payment network 2000 or issuer 1500 recalculates the amount owed on the transaction based on the sliding scale, presenting the proposed recalculated amount to the merchant 1300. The merchant can then either adopt or reject the proposed recalculated amount for the transaction.

After a transaction is captured, a clearing process occurs.

Eventually, the transaction is settled between the merchant 1300, the acquirer 1400, and the issuer 1500.

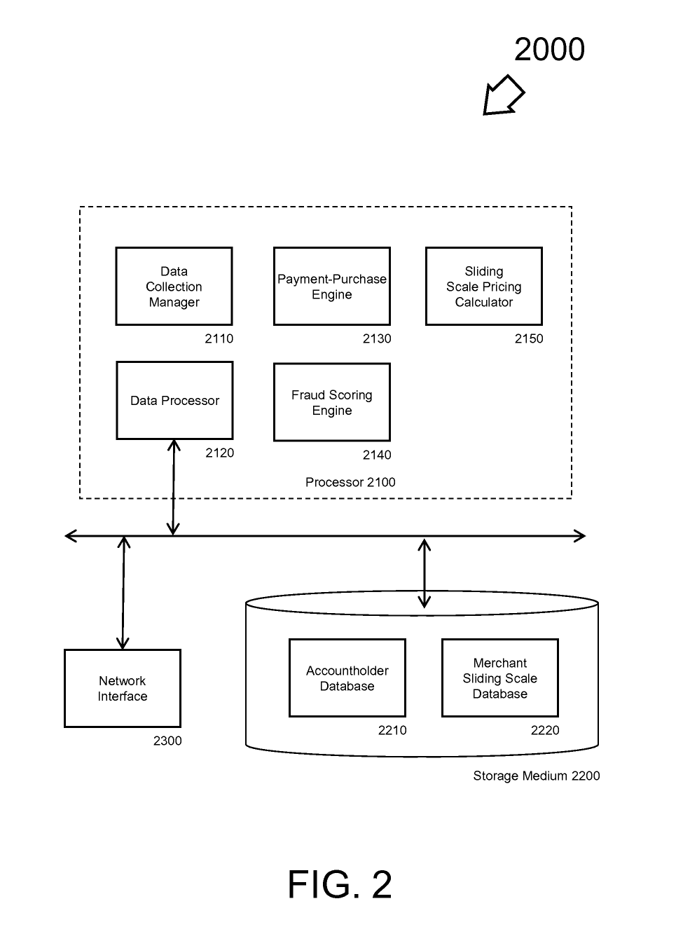

Embodiments will now be disclosed with reference to a block diagram of an exemplary payment network server 2000 of FIG. 2, configured to make fee assessments and allowing merchants to determine payments owed by each accountholder, constructed and operative in accordance with an embodiment of the present disclosure. While payment network server is described as being part of payment network 2000, it is understood that in some embodiments the payment network server described herein could be located at an issuer 1500.

Payment network server 2000 may run a multi-tasking operating system (OS) and include at least one processor or central processing unit (CPU) 2100, a non-transitory computer-readable storage medium 2200, and a network interface 2300.

Processor 2100 may be any central processing unit, microprocessor, micro-controller, computational device or circuit known in the art. It is understood that processor 2100 may temporarily store data and instructions in a Random Access Memory (RAM) (not shown), as is known in the art.

As shown in FIG. 2, processor 2100 is functionally comprised of a data collection manager 2110, a payment-purchase engine 2130, a data processor 2120, a fraud scoring engine 2140, and a sliding scale pricing calculator 2150.

Data processor 2120 interfaces with storage medium 2200 and network interface 2300. The data processor 2120 enables processor 2100 to locate data on, read data from, and writes data to, these components.

Payment-purchase engine 2130 performs payment and purchase transactions, and may do so in conjunction with data collection manager 2110.

Data collection manager 2110 is the structure that facilitates input of sliding scale accountholder information. The sliding scale accountholder information is supplied by the accountholder when they opt-into a sliding scale pricing program. In some embodiments, the data collection manager 2110 is a World-Wide-Web interface that allows the accountholder to load information into the accountholder database 2210. In other embodiments where the accountholder has supplied sliding scale accountholder information to merchant 1300, data collection manager 2110 may receive the information directly from merchant 1300.

In some embodiments, data collection manager 2110 may include telephone support, mail processing, or receive third party data extracts stored locally.

Sliding scale accountholder information may include, but is not limited to:

income information, including pay stubs, tax returns, and social entitlements;

insurance information;

asset information, including bank accounts, investment accounts, and real property information;

debt information, including loan information and credit line information;

dependent information, including minor children and other dependents;

association information, such as union membership and the like; and

privacy information, including which merchants are allowed to access (or denied access to) the above information.

Accountholder information is stored in an accountholder database 2210.

In some embodiments, data collection manager 2110 may include telephone support, mail processing, or receive third party data extracts stored locally at accountholder database 2210.

Sliding scale pricing calculator 2150 is configured to apply merchant sliding scale rules (also referred to as a “billing scale entry”), which are saved in a merchant sliding scale database 2220, to determine whether an accountholder qualifies for sliding scale pricing. A billing scale entry may include billing scale requirements and a billing scale. The billing scale requirements determine the qualifications for the billing scale. When the accountholder qualifies for sliding scale pricing, the sliding scale pricing calculator 2150 recalculates the amount owed on the transaction based on the sliding scale, presenting the proposed recalculated amount to the merchant 1300. The merchant 1300 can then either adopt or reject the proposed recalculated amount for the transaction.

Merchant sliding scale rules may be collected from merchant 1300 on a periodic basis, and may include, but is not limited to:

algorithms to calculate fees, and may be based on information stored by payment network 2000;

information collected by merchant 1300, such as treatment plans, visit frequency, available assistance;

pricing data, including the service rendered; and

pricing tiers and cost for each service.

These structures may be implemented as hardware, firmware, or software encoded on a computer readable medium, such as storage medium 2200. Further details of these components are described with their relation to method embodiments below.

Computer-readable storage medium 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. In some embodiments, computer-readable storage medium 2200 may be remotely located from processor 2100, and be connected to processor 2100 via a network such as a local area network (LAN), a wide area network (WAN), or the Internet.

In addition, as shown in FIG. 2, storage medium 2200 may also contain an accountholder database 2210 and a merchant sliding scale database 2220. Accountholder database 2210 contains information about an accountholder, including payment accounts (and their Primary Account Numbers) associated with an accountholder, an account transaction history, and any information collected by the data collection manager 2110. Merchant sliding scale database 2220 is configured to store merchant sliding scale rules, which define the conditions and requirements for a sliding scale pricing at a merchant 1300. Merchant sliding scale rules are provided by merchant 1300 when the merchant decides to allow sliding scale pricing assessments to be made by payment network server 2000.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows payment network server 2000 to communicate with acquirer 1400 and issuer 1500.

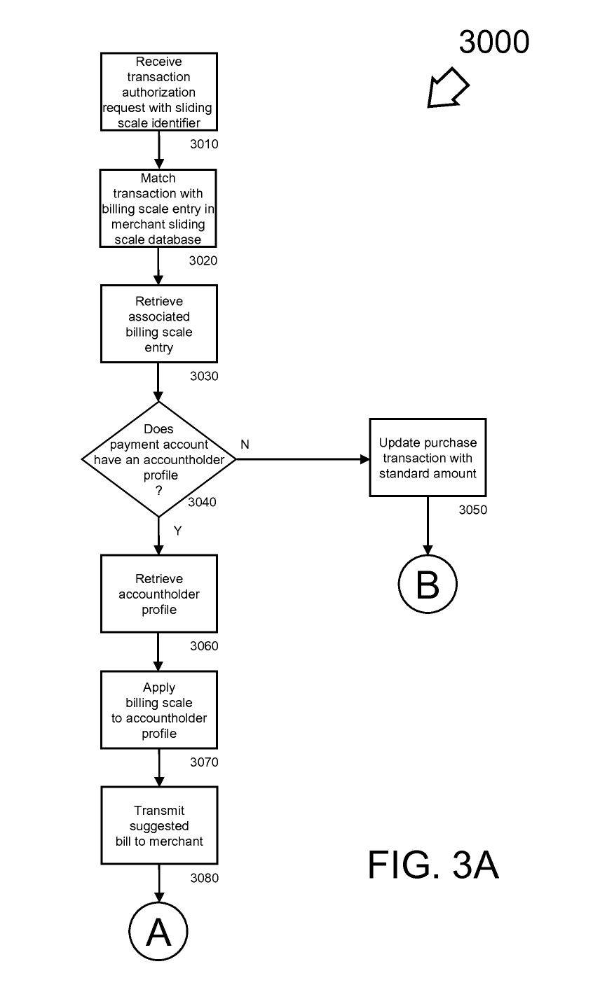

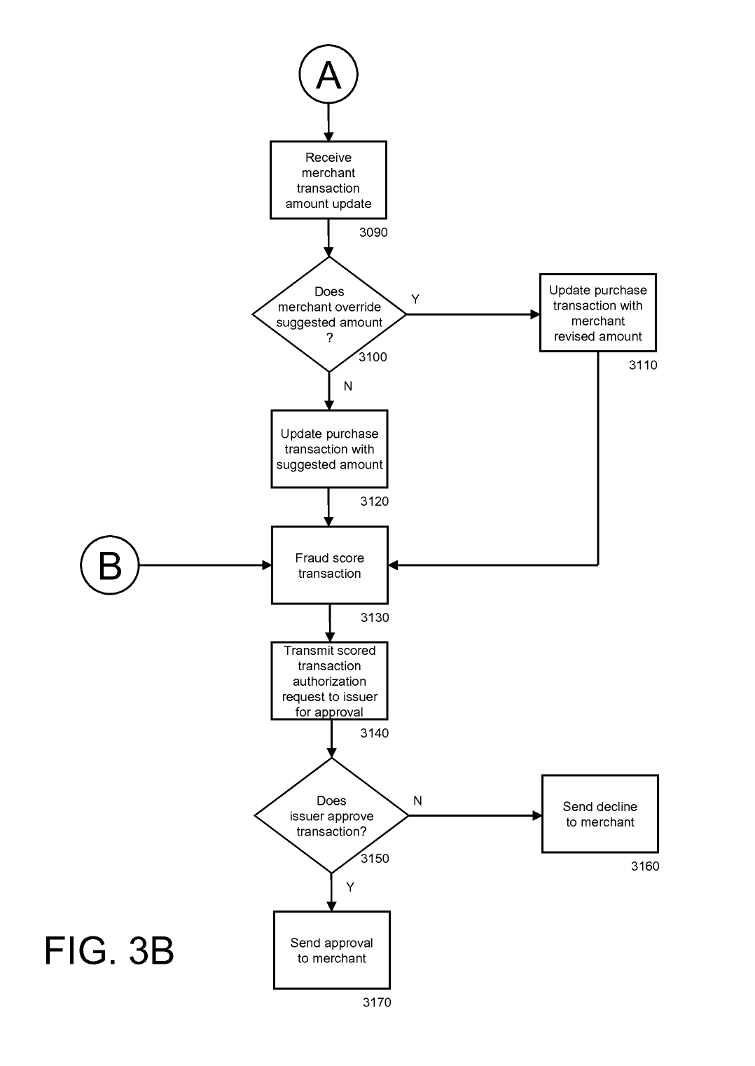

We now turn our attention to a method or process embodiment of the present disclosure, FIGS. 3A-3B. It is understood by those known in the art that instructions for such method embodiments may be stored on their respective computer-readable memory and executed by their respective processors. It is understood by those skilled in the art that other equivalent implementations can exist without departing from the spirit or claims of the invention.

FIG. 3 illustrates a process 3000, from the perspective of a payment network server 2000, to reduce the computational burden of commercial enterprises supplying sliding scale fees, constructed and operative in accordance with an embodiment of the present disclosure. It is understood by those familiar with the art that process 3000 is a real-time authentication process.

At block 3010, payment network 2000 receives a transaction authorization request from a merchant bank 1400. The transaction authorization request is received electronically via a network interface 2300, and contains transaction data including: an account identifier for a payment account (which can be a Primary Account Number), a merchant identifier, an amount of the transaction, a transaction type (purchase, return, cash-advance, and the like), and a sliding scale identifier. The sliding scale identifier identifies the item or items in the transaction that may be subject to a sliding scale payment. Suppose, for example, the merchant offers necessities, such as food, on a need-based sliding scale payment program. In this case, the necessities may be marked for with sliding scale identifier, while luxury items (non-necessities) are not marked.

Payment-purchase engine 2130 matches the transaction authorization request with a billing scale entry in the merchant sliding scale database 2220, block 3020. Generally, the combination of the merchant identifier and sliding scale identifier of the transaction authorization request is used for the matching.

At block 3030, the sliding scale pricing calculator 2150 retrieves the associated billing scale entry from the merchant sliding scale database 2220.

At decision block 3040, the sliding scale pricing calculator 2150 determines whether the payment account (identified via the account identifier) has an associated accountholder profile stored in the accountholder database 2210.

If the payment account does not have an accountholder profile, as determined at decision block 3040, the accountholder automatically does not qualify for the sliding scale pricing via process 3000, the purchase transaction is updated with the standard amount for the item, block 3050, and the authorization process 3000 continues at block 3130.

If the payment account has an accountholder profile, as determined at decision block 3040, the process continues at block 3060.

At block 3060, the sliding scale pricing calculator 2150 retrieves the account holder profile.

The billing scale is applied to the accountholder profile by the sliding scale pricing calculator 2150, block 3070. Sliding scale accountholder information is used to access the accountholder's qualification (need, income, assets, and the like) and calculate payment (pricing tiers, fee algorithms and the like) under the sliding scale pricing program. Algorithms provided by the merchant 1300 are applied to determine the cost of the sliding scale priced goods and services, resulting in a revised suggested bill amount.

The suggested bill amount is transmitted to merchant 1300 by network interface 2300 for approval, block 3080.

At this point, the merchant 1300, can either adopt the suggested bill amount or revise the transaction amount in a merchant transaction amount update. At block 3090, network interface 2300 receives the merchant transaction amount update. In some embodiments, the merchant transaction amount update may be a new (or same) amount specified for the transaction. In other embodiments, the merchant transaction amount update may be an identifier signifying whether the suggested bill amount or original bill amount should be adopted.

When the merchant decides to override the suggested bill amount, as determined at decision block 3100, the purchase transaction is updated with the merchant revised amount, block 3110, and the process continues at block 3130.

When the merchant declines to override the suggested bill amount, as determined at decision block 3100, the purchase transaction is updated with the suggested bill amount, block 31120, and the process continues at block 3130.

At block 3130, fraud scoring engine 2140 fraud scores the transaction using the applicable bill amount. Fraud scoring refers to an indication, or likelihood, that a payment transaction is fraudulent. In one embodiment, the fraud scoring engine 2140 provides a number back to the payment card issuer between zero and 1,000, which translates into zero and 100 percent, in tenths of percentage points. The fraud-scoring is based at least in part on the transaction authorization request and prior spending behavior as derived from the accountholder database 2210.

Payment network 2000 transmits the scored transaction authorization request to issuer 1500 for approval, block 3140. The authorization transaction message including the type of transaction, a merchant identifier, the amount of transaction, and an account identifier; the account identifier may be a Primary Account Number or other representation of an account.

Depending upon the issuer 1500 approval of the transaction, as determined at decision block 3150, an approval message is sent to merchant 1300, block 3170, or a decline message is sent, block 3160.

### Use Examples

It is understood that the system described herein may be applied to a variety of different applications. This section describes some of the possible applications.

In one embodiment, the system described herein may be used in a medical provider context. Suppose an accountholder requires medical care from a number of different area clinics. The accountholder provides all of their relevant income, asset, and dependent information to the accountholder database 2210 as an alternative to providing their information to each individual clinic. The clinics provide their pricing algorithms to the merchant sliding scale database 2220. As a result, the clinics are able to apply sliding scale payments without the administrative overhead of collecting the patient's information.

In an insurance-related embodiment, insurance coverage may be used to calculate the sliding scale payments. The accountholder data would include any insurance policy information, while merchant sliding scale database 2220 would include insurance policy rules, which define the conditions and requirements for a sliding scale (insurance policy) pricing at a merchant 1300. In another embodiment, an insurance company could be a third-party payer and the insurance company would only be charged the patient's liability.

In an alternate embodiment, a merchant 1300 changes their fees for different, established pricing tiers. The merchant 1300 can update their pricing with the merchant sliding scale database 2220 and all future billing is handled without having to make updates within their own system.

In another embodiment, the system described herein may be used in a service provider context. Suppose a service provider, such as a lawyer, bills clients based on an hourly rate. Instead of passing a transaction amount to the payment network 2000, the service provider passes the number of hourly units that the accountholder utilized. A fee is determined and multiplied times the number of hours utilized in order to calculate the charge to the accountholder.

In some embodiments, accountholders may opt to share their sliding scale data (stored within the accountholder database) with some merchants 1300, but not others. For example, an accountholder may decide to share their sliding scale information with their psychotherapist, but elect to withhold the same information from their attorney. As a result, sliding scale payments are calculated during transaction processing for psychotherapy, but their lawyer must handle their billing without the services of process 3000.

It is understood by those familiar with the art that the system described herein may be implemented in hardware, firmware, or software encoded on a non-transitory computer-readable storage medium.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A real-time method to process a payment transaction, the method comprising:
receiving, with a network interface, transaction data from a merchant bank, the transaction data describing the payment transaction and including: an account identifier associated with the accountholder, a merchant identifier, an amount of the transaction and a sliding scale identifier;
matching, with a processor, the merchant identifier and the sliding scale identifier with a billing scale entry in a database, the billing scale entry including billing scale requirements and a billing scale;
matching, with a processor, the account identifier with an accountholder entry in a database, the accountholder entry including accountholder data;
determining, with the processor, whether the accountholder qualifies for sliding scale pricing based at least in part on the billing scale requirements and the accountholder data;
calculating, with the processor, a suggested bill amount based on the billing scale entry when the accountholder qualifies for sliding scale pricing;
transmitting to the merchant bank, with the network interface, the suggested bill amount when the accountholder qualifies for sliding scale pricing.

2. The processing method of claim 1, wherein the billing scale includes pricing tiers or hourly rates.

3. The processing method of claim 2, wherein the billing scale requirements include income, insurance, asset, debt, dependent or association qualifications.

4. The processing method of claim 3, wherein the accountholder data includes income, insurance, asset, debt, dependent or association qualifications.

5. The processing method of claim 4, wherein the accountholder data further includes privacy information indicating selected merchants allowed access to the accountholder data.

6. The processing method of claim 5, wherein the privacy information further indicates selected merchants not allowed access to the accountholder data.

7. The processing method of claim 6, further comprising:
receiving, with the network interface, a merchant transaction amount update;
updating the amount of the transaction with the merchant transaction amount update with the processor;
fraud scoring the payment transaction based at least in part on the transaction data and the accountholder entry, resulting in a fraud score; and,
transmitting, with the network interface, to an issuer of the account identifier: the transaction data and the fraud score.

8. A real-time system to process a payment transaction, the system comprising:
a network interface configured to receive transaction data from a merchant bank, the transaction data describing the payment transaction and including: an account identifier associated with the accountholder, a merchant identifier, an amount of the transaction and a sliding scale identifier;
a processor configured to match the merchant identifier and the sliding scale identifier with a billing scale entry in a database, the billing scale entry including billing scale requirements and a billing scale, to match the account identifier with an accountholder entry in a database, the accountholder entry including accountholder data, to determine whether the accountholder qualifies for sliding scale pricing based at least in part on the billing scale requirements and the accountholder data, and to calculate a suggested bill amount based on the billing scale entry when the accountholder qualifies for sliding scale pricing; and,
the network interface is further configured to transmit to the merchant bank the suggested bill amount when the accountholder qualifies for sliding scale pricing.

9. The processing system of claim 8, wherein the billing scale includes pricing tiers or hourly rates.

10. The processing system of claim 9, wherein the billing scale requirements include income, insurance, asset, debt, dependent or association qualifications.

11. The processing system of claim 10, wherein the accountholder data includes income, insurance, asset, debt, dependent or association qualifications.

12. The processing system of claim 11, wherein the accountholder data further includes privacy information indicating selected merchants allowed access to the accountholder data.

13. The processing system of claim 12, wherein the privacy information further indicates selected merchants not allowed access to the accountholder data.

14. The processing system of claim 13, wherein:
the network interface is further configured to receive a merchant transaction amount update;
the processor is further configured to update the amount of the transaction with the merchant transaction amount update, to fraud score the payment transaction based at least in part on the transaction data and the accountholder entry, resulting in a fraud score; and,
the network interface is further configured to transmit to an issuer of the account identifier: the transaction data and the fraud score.

15. A non-transitory computer-readable medium encoded with data and instructions, when executed by a computing device the instructions cause the computing device to:
receive, with a network interface, transaction data from a merchant bank, the transaction data describing the payment transaction and including: an account identifier associated with the accountholder, a merchant identifier, an amount of the transaction and a sliding scale identifier;
match, with a processor, the merchant identifier and the sliding scale identifier with a billing scale entry in a database, the billing scale entry including billing scale requirements and a billing scale;
match, with a processor, the account identifier with an accountholder entry in a database, the accountholder entry including accountholder data;
determine, with the processor, whether the accountholder qualifies for sliding scale pricing based at least in part on the billing scale requirements and the accountholder data;
calculate, with the processor, a suggested bill amount based on the billing scale entry when the accountholder qualifies for sliding scale pricing;
transmit to the merchant bank, with the network interface, the suggested bill amount when the accountholder qualifies for sliding scale pricing.

16. The computer-readable medium of claim 15, wherein the billing scale includes pricing tiers or hourly rates.

17. The computer-readable medium of claim 16, wherein the billing scale requirements include income, insurance, asset, debt, dependent or association qualifications.

18. The computer-readable medium of claim 17, wherein the accountholder data includes income, insurance, asset, debt, dependent or association qualifications.

19. The computer-readable medium of claim 18, wherein the accountholder data further includes privacy information indicating selected merchants allowed access to the accountholder data.

20. The computer-readable medium of claim 19, wherein the privacy information further indicates selected merchants not allowed access to the accountholder data.
